(19) United States
(12) Patent Application Publication
(10) Pub. No.: US 2024/0397028 A1
(43) Pub. Date: Nov. 28, 2024

(54) THREE-DIMENSIONAL DISPLAY DEVICE

(71) Applicant: AUO Corporation, Hsin-Chu (TW)

(72) Inventor: Ming-Hsuan YU, Hsin-Chu (TW)

(21) Appl. No.: 18/391,397

(22) Filed: Dec. 20, 2023

(30) Foreign Application Priority Data
May 26, 2023 (TW) 112119700

(51) Int. Cl. H04N 13/302; H04N 13/351

(52) U.S. Cl. CPC H04N 13/302; H04N 13/351; H04N 2213/001

(57) ABSTRACT

A three-dimensional display device includes a base, a rotating table and at least one transparent double-sided display panel. The rotating table is rotatably connected to the base. The at least one transparent double-sided display panel is disposed on the rotating table. The at least one transparent double-sided display panel has a first display surface and a second display surface opposite to each other.

### CROSS-REFERENCE TO RELATED PATENT APPLICATION

This non-provisional application claims priority to and the benefit of, pursuant to 35 U.S.C. § 119(a), patent application Serial No. 112119700 filed in Taiwan on May 26, 2023. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present disclosure relates to a display device, and particularly to a three-dimensional display device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

With the development of three-dimensional display technology, there are broad prospects for applications in virtual reality, gaming, advertising, and other fields. For example, two display surfaces may be utilized (such as disposing two advertising screens at a street corner) to allow a viewer standing at a specific position to see the two display surfaces and perceive depth information to create a three-dimensional sense. Alternatively, a display rotating fan and three-dimensional post-production images may be utilized to allow the viewer standing in front of an object to see a three-dimensional image of the foreground and the background, thus creating a three-dimensional sense for the viewer that the object is truly floating. Alternatively, a pair of three-dimensional glasses may be worn by the viewer, allowing the left and right eyes to see different images, thus creating a visual difference and generating a three-dimensional stereoscopic image.

However, the three-dimensional display methods all require specific angles and images, and the three-dimensional stereoscopic images cannot be viewed with naked eyes from any angle.

### SUMMARY

The present disclosure provides a three-dimensional display device, which may generate three-dimensional stereoscopic images viewable with naked eyes, without the limitation of the viewing angles.

The three-dimensional display device according to certain embodiments of the present disclosure includes a base, a rotating table and at least one transparent double-sided display panel. The rotating table is rotatably connected to the base. The at least one transparent double-sided display panel is disposed on the rotating table. The at least one transparent double-sided display panel has a first display surface and a second display surface opposite to each other.

In one embodiment of the present disclosure, the first display surface and the second display surface of each of the at least one transparent double-sided display panel have different display images at a same point of time.

In one embodiment of the present disclosure, a distance between the first display surface and the second display surface is greater than 0. At the same point of time, the display image of the first display surface and the display image of the second display surface are two-dimensional images of different sectional surfaces of a three-dimensional object.

In one embodiment of the present disclosure, the three-dimensional display device further includes a circuit assembly. The rotating table has an upper surface and a lower surface opposite to each other. The at least one transparent double-sided display panel is disposed on the upper surface. The circuit assembly is disposed on the lower surface. The circuit assembly is located between the base and the at least one transparent double-sided display panel.

In one embodiment of the present disclosure, the circuit assembly includes at least one driving circuit board, a motor and at least one battery. The motor and the at least one battery are electrically connected to the at least one driving circuit board, and the motor drives the rotating table to rotate.

In one embodiment of the present disclosure, the circuit assembly further includes a wireless charging coil. The wireless charging coil is disposed on the base and corresponds to the at least one battery to perform wireless charging to the at least one battery.

In one embodiment of the present disclosure, the three-dimensional display device further includes a plurality of ball bearings. The base includes a plurality of bearing fixing portions. The ball bearings are respectively disposed on the corresponding bearing fixing portions, and the ball bearings are connected between the base and the rotating table.

In one embodiment of the present disclosure, the three-dimensional display device further includes a transparent cover. The transparent cover and the base are hermetically combined to form an accommodating space. The rotating table and the at least one transparent double-sided display panel are located in the accommodating space.

In one embodiment of the present disclosure, each of the at least one transparent double-sided display panel has a plurality of through holes.

Based on the foregoing, in the three-dimensional display device according to certain embodiments of the present disclosure, the rotating table rotates along with the transparent double-sided display panel relative to the base, and each transparent double-sided display panel is transparent and displays on both sides, such that each transparent double-sided display panel may display two dimensional images of different sectional surfaces of a three-dimensional object at different points of time, thereby allowing the transparent double-sided display panel to form a continuous three-dimensional stereoscopic image of the object to be displayed through visual persistence.

Thus, the three-dimensional display device according to certain embodiments of the present disclosure may generate a continuous three-dimensional stereoscopic image viewable with naked eyes by the base, the rotating table and the transparent double-sided display panel, such that the viewer may directly perceive the distance and depth of the object in the image, and may obtain more comprehensive and intuitive information without being limited by the viewing angle.

These and other aspects of the present disclosure will become apparent from the following description of the embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective schematic view of a three-dimensional display device according to one embodiment of the present disclosure.

FIG. 2 is an exploded schematic view of the three-dimensional display device of FIG. 1.

FIG. 3A is a side schematic view of one of the transparent double-sided display panels of the three-dimensional display device of FIG. 1.

FIG. 3B is a top schematic view of FIG. 3A.

FIG. 4 is a top schematic view of the transparent double-sided display panel of FIG. 3B displaying different sectional surfaces of a three-dimensional object at different points of time.

FIG. 5A is a top schematic view of one of the transparent double-sided display panels of a three-dimensional display device according to another embodiment of the present disclosure.

FIG. 5B is a top schematic view of one of the transparent double-sided display panels of a three-dimensional display device according to another embodiment of the present disclosure.

FIG. 6 is a side schematic view of one of the transparent double-sided display panels of a three-dimensional display device according to another embodiment of the present disclosure.

FIG. 7 is a perspective schematic view of a three-dimensional display device according to another embodiment of the present disclosure.

FIG. 8A is a perspective schematic view of a rotating table, transparent double-sided display panels and a motor of a three-dimensional display device according to another embodiment of the present disclosure.

FIG. 8B is a perspective schematic view of a rotating table, transparent double-sided display panels and a motor of a three-dimensional display device according to a further embodiment of the present disclosure.

FIG. 9 is a perspective schematic view of a rotating table, transparent double-sided display panels and a motor of a three-dimensional display device according to yet another embodiment of the present disclosure.

### DETAILED DESCRIPTION

The terms “about”, “approximately”, “essentially” or “substantially” as used herein shall cover the values described, and cover an average value of an acceptable deviation range of the specific values ascertained by one of ordinary skill in the art, where the deviation range may be determined by the measurement described and specific quantities of errors related to the measurement (that is, the limitations of the measuring system). For example, the term “about” represents within one or more standard deviations of a given value of range, such as within ±30 percent, within ±20 percent, within ±15 percent, within ±10 percent or within ±5 percent. Moreover, the terms “about”, “approximately”, “essentially” or “substantially” as used herein may selectively refer to a more acceptable deviation range or the standard deviation based on the measuring characteristics, the cutting characteristic or other characteristics, without applying one standard deviation to all characteristics.

In the accompanying drawings, for clarity purposes, the thickness of a layer, a film, a panel, a region, etc. may be enlarged. It should be understood that when one component such as a layer, a film, a region or a substrate is referred to as being disposed “on” the other component or “connected to” the other component, the component may be directly disposed on the other component or connected to the other component, or an intermediate component may also exist between the two components. In contrast, when one component is referred to as being “directly disposed on the other component” or “directly connected to” the other component, no intermediate component exists therebetween. As used herein, a “connection” may be a physical and/or electrical connection. In addition, when two components are “electrically connected”, other components may exist between the two components.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Furthermore, relative terms, such as “lower” or “bottom”, “upper” or “top”, and “left” and “right”, may be used herein to describe the relationship between one component and the other component as illustrated in the drawings. It should be understood that the relative terms are intended to encompass different orientations of the device in addition to the orientation in the drawings. For example, if the device in one of the drawings is turned over, components described as being on the “lower” side of other components would then be oriented on “upper” sides of the other components. The exemplary term “lower” can therefore encompasses both an orientation of “lower” and “upper,” depending on the particular orientation of the accompanying drawings. Similarly, if the device in one of the drawings is turned over, components described as “below” or “beneath” other components would then be oriented “above” the other components. The exemplary terms “below” or “beneath” can therefore encompass both an orientation of being above and below.

The present disclosure will now be described hereinafter in details with reference to the accompanying drawings, in which exemplary embodiments of the disclosure are shown. Whenever possible, identical reference numerals refer to identical or like elements in the drawings and descriptions.

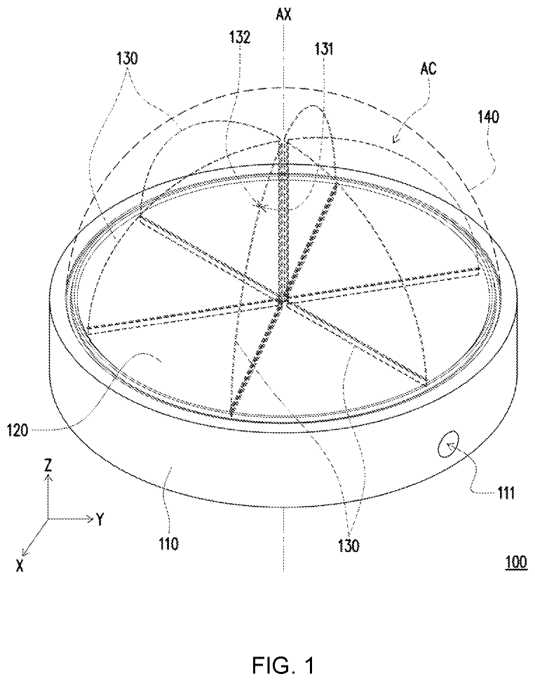

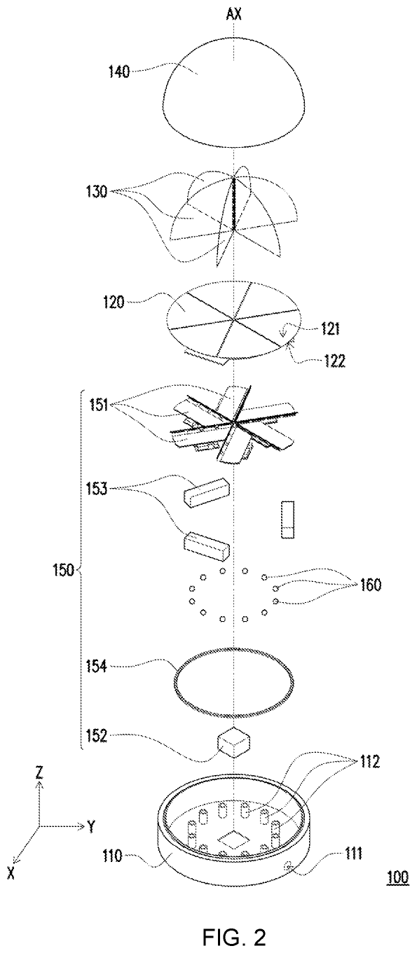

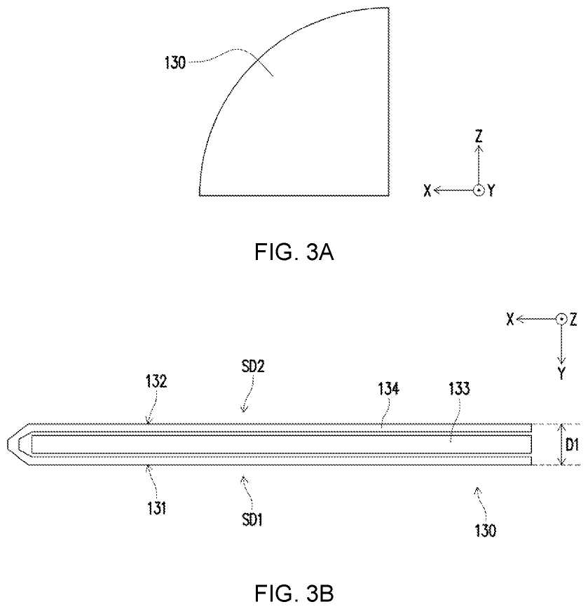

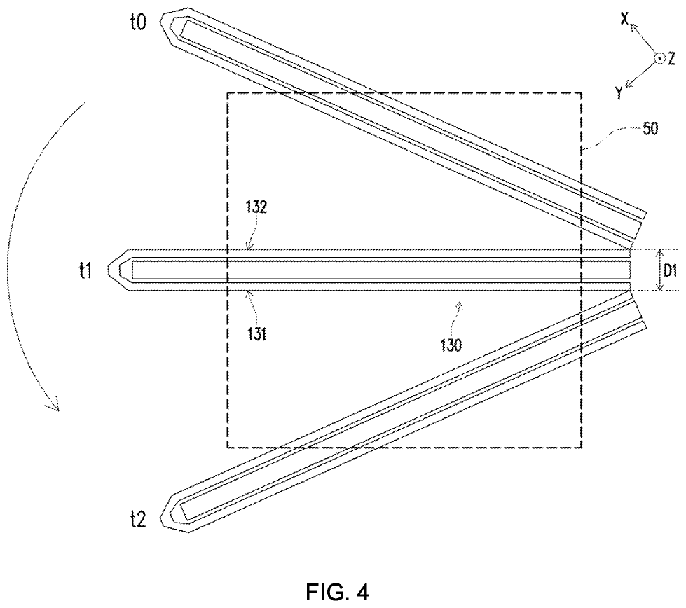

FIG. 1 is a perspective schematic view of a three-dimensional display device according to one embodiment of the present disclosure. FIG. 2 is an exploded schematic view of the three-dimensional display device of FIG. 1. FIG. 3A is a side schematic view of one of the transparent double-sided display panels of the three-dimensional display device of FIG. 1. FIG. 3B is a top schematic view of FIG. 3A. FIG. 4 is a top schematic view of the transparent double-sided display panel of FIG. 3B displaying different sectional surfaces of a three-dimensional object at different points of time.

It should be noted that the Cartesian coordinates X-Y-Z are provided for the subsequent description and reference of the components. Further, to clearly describe the three-dimensional display device 100, FIG. 1 depicts the transparent double-sided display panels 130 and the transparent cover 140 in broken lines. In addition, FIG. 4 depicts the three-dimensional object 50 in broken lines.

Referring to FIG. 1, the three-dimensional display device 100 in the present embodiment includes a base 110, a rotating table 120 and six transparent double-sided display panels 130. The rotating table 120 is rotatably connected to the base 110. The six transparent double-sided display panels 130 are disposed on the rotating table 120, and each transparent double-sided display panel 130 has a first display surface 131 and a second display surface 132 opposite to each other, allowing the rotating table 120 to rotate along with the six transparent double-sided display panels 130 relative to the base 110.

It should be noted herein that, referring to FIG. 1 and FIG. 2, in the present embodiment, the rotating table 120 is, for example, a round-shaped rotating table rotating around a rotation axis AX (parallel to the Z-axis), and the six transparent double-sided display panels 130 are, for example, arranged radially with the rotation axis AX as the central axis, without being limited thereto. Referring to FIG. 3A, in the present embodiment, the contour of each transparent double-sided display panel 130 is substantially a quarter circle, without being limited thereto. Referring to FIG. 3B, in the present embodiment, each transparent double-sided display panel 130 includes, for example, a supporting member 133 and a substrate 134 disposed on the supporting member 133. The substrate 134 is folded and disposed on a first side SD1 and a second side SD2 of the transparent double-sided display panel 130 opposite to each other, thus forming a first display surface 131 at the first side SD1 and forming a second display surface 132 at the second side SD2, without being limited thereto.

Specifically, referring to FIG. 2, in the present embodiment, the three-dimensional display device 100 further includes a transparent cover 140 and a circuit assembly 150. The transparent cover 40 and the base 110 are hermetically combined to form an accommodating space AC (see FIG. 1), and the rotating table 120 and the six transparent double-sided display panels 130 are located in the accommodating space AC (see FIG. 1). The rotating table 120 has an upper surface 121 and a lower surface 122 opposite to each other. The six transparent double-sided display panels 130 are disposed on the upper surface 121 along the Z-axis, and the circuit assembly 150 is disposed on the lower surface 122. The circuit assembly 150 is located between the base 110 and the six transparent double-sided display panels 130.

It should be noted herein that, referring to FIG. 1 and FIG. 2, in the present embodiment, the base 110 has, for example, an opening hole 111, and the three-dimensional display device 100 may utilize the opening hole 111 to evacuate the vacuum to maintain a vacuum state in the accommodating space AC (see FIG. 1), thus reducing the resistance exerted by the air when the transparent double-sided display panels 130 rotate, thereby avoiding damage to the transparent double-sided display panels 130 and reducing the power consumption required for the rotation, without being limited thereto.

In details, referring to FIG. 2, in the present embodiment, the circuit assembly 150 includes six driving circuit boards 151, a motor 152, three batteries 153 and a wireless charging coil 154. The motor 152 and the batteries 153 are electrically connected to the corresponding driving circuit boards 151, and the motor 152 is fixed to the base 110 and drives the rotating table 120 to rotate. The wireless charging coil 154 is disposed on the base 110 and corresponds to the three batteries 153 to perform wireless charging to the batteries 153.

It should be noted herein that, referring to FIG. 2, in the present embodiment, each driving circuit board 151 adopts, for example, an irregular design, that is, as each driving circuit board 151 approaches the rotation axis AX (parallel to the Z-axis), the width of the board body of the driving circuit board 151 correspondingly decreases, thus avoiding structural interference with the adjacent driving circuit boards 151, without being limited thereto. Referring to FIG. 2, in the present embodiment, the three batteries 153 are fixed and evenly distributed below the rotating table 120 to distribute the weights of the three batteries 153, without being limited thereto.

In more details, referring to FIG. 2, in the present embodiment, the three-dimensional display device 100 further includes a plurality of ball bearings 160, and the base 110 includes a plurality of bearing fixing portions 112 correspondingly. The ball bearings 160 are respectively disposed on the corresponding bearing fixing portions 112, and the ball bearings 160 are connected between the base 110 and the rotating table 120, thus assisting in supporting the rotating table 120 and the weights of the related components connected to the rotating table 120.

Further, referring to FIG. 3B and FIG. 4, in the present embodiment, a distance D1 between the first display surface 131 and the second display surface 132 of each transparent double-sided display panel 130 is greater than 0. In other words, since the distance D1 between the first display surface 131 and the second display surface 132 is greater than 0, when each transparent double-sided display panel 130 is at a same point of time (such as the zeroth point of time t0, the first point of time t1 or the second point of time t2 in FIG. 4), the display image of the first display surface 131 and the display image of the second display surface 132 are two-dimensional images of different sectional surfaces of the three-dimensional object 50.

Further, referring to FIG. 4, in the present embodiment, since the motor 152 (see FIG. 2) is fixed on the base 110 and drives the rotating table 120 to rotate, the six transparent double-sided display panels 130 (with only one being shown in FIG. 4) disposed on the rotating table 120 also rotate relative to the base 110, thereby allowing the display image of the first display surface 131 and the display image of the second display surface 132 of each transparent double-sided display panel 130 to represent two-dimensional images of different sectional surfaces of the three-dimensional object 50 at different points of time (for example, rotating sequentially from a location at the zeroth point of time t0 to a location at the first point of time t1 and a location at the second point of time t2 in FIG. 4).

It should be noted herein that, referring to FIG. 4, in the present embodiment, each transparent double-sided display panel 130 rotates sequentially from the location at the zeroth point of time t0 to the location at the first point of time t1 and the location at the second point of time t2, and the rotating angle of each transparent double-sided display panel 130 from the location at the zeroth point of time t0 to the location at the second point of time t2 is, for example, 60 degrees, but the present disclosure does not limit the rotating angle of each transparent double-sided display panel 130 from the location at the zeroth point of time t0 to the location at the second point of time t2.

In other words, in the present embodiment, the rotating table 120 rotates along with the six transparent double-sided display panels 130 relative to the base 110, and each transparent double-sided display panel 130 is transparent and displays on both sides, such that each transparent double-sided display panel 130 may display two dimensional images of different sectional surfaces of the three-dimensional object 50 at different points of time, thereby allowing each transparent double-sided display panel 130 to form a continuous three-dimensional stereoscopic image of the three-dimensional object 50 to be displayed through visual persistence.

Thus, the three-dimensional display device 100 in the present embodiment may generate a continuous three-dimensional stereoscopic image viewable with naked eyes by the base 110, the rotating table 120 and the transparent double-sided display panels 130, such that the viewer may directly perceive the distance and depth of the object in the image, and may obtain more comprehensive and intuitive information without being limited by the viewing angle.

It should be noted that the following embodiments use the reference numerals and certain contents of the aforementioned embodiment, in which identical or similar components are identified by identical reference numerals, and descriptions of the identical technical contents will be omitted. The omitted descriptions may be referenced to in the aforementioned embodiment, and are not hereinafter reiterated in the following embodiments.

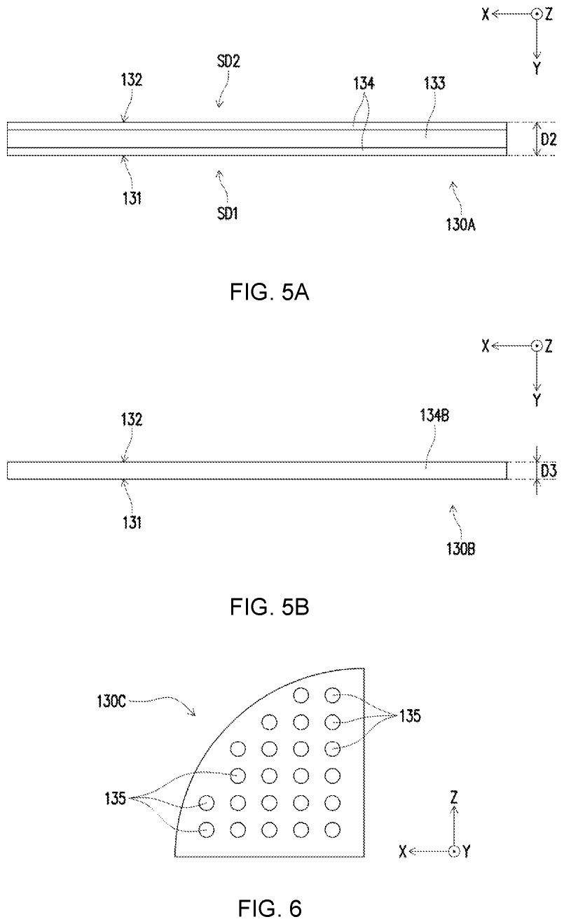

FIG. 5A is a top schematic view of one of the transparent double-sided display panels of a three-dimensional display device according to another embodiment of the present disclosure. Referring simultaneously to FIG. 5A and FIG. 3B, the transparent double-sided display panels 130A in the present embodiment are similar to the transparent double-sided display panels 130 of FIG. 3B, and the difference between the two exists in that the quantity of the substrates 134 is, for example, two.

Referring to FIG. 5A, each transparent double-sided display panel 130A in the present embodiment includes a supporting member 133 and two substrates 134 disposed on the supporting member 133. The two substrates 134 are respectively disposed on a first side SD1 and a second side SD2 of the transparent double-sided display panel 130A opposite to each other, thus forming the first display surface 131 and the second display surface 132 opposite to each other.

In detail, in the present embodiment, a distance D2 between the first display surface 131 and the second display surface 132 of each transparent double-sided display panel 130A is greater than 0. In other words, since the distance D2 between the first display surface 131 and the second display surface 132 is greater than 0, when each transparent double-sided display panel 130A is at a same point of time, the display image of the first display surface 131 and the display image of the second display surface 132 are two-dimensional images of different sectional surfaces of the three-dimensional object (not shown).

In more details, in the present embodiment, since the transparent double-sided display panels 130A rotate along with the rotating table (not shown) relative to the base (not shown), the display image of the first display surface 131 and the display image of the second display surface 132 of each transparent double-sided display panel 130A are two-dimensional images of different sectional surfaces of the three-dimensional object (not shown).

In other words, in the present embodiment, the rotating table (not shown) rotates along with the transparent double-sided display panels 130A relative to the base (not shown), and each transparent double-sided display panel 130A is transparent and displays on both sides, such that each transparent double-sided display panel 130A may display two dimensional images of different sectional surfaces of the three-dimensional object (not shown) at different points of time, thereby forming a continuous three-dimensional stereoscopic image of the three-dimensional object (not shown) to be displayed through visual persistence, thus further generating continuous three-dimensional stereoscopic image viewable with naked eyes, without being limited by the viewing angle.

FIG. 5B is a top schematic view of one of the transparent double-sided display panels of a three-dimensional display device according to another embodiment of the present disclosure. Referring simultaneously to FIG. 5B and FIG. 3B, the transparent double-sided display panels 130B in the present embodiment are similar to the transparent double-sided display panels 130 of FIG. 3B, and the difference between the two exists in that each transparent double-sided display panel 130B include a single substrate 134B and without the supporting member 133.

Referring to FIG. 5B, in the present embodiment, each transparent double-sided display panel 130B includes a substrate 134B, and a front surface and a reverse surface (that is, the first display surface 131 and the second display surface 132) of the substrate 134B are provided with, for example, a plurality of micro light emitting diodes (not shown). Alternatively, a plurality of micro light emitting diodes (not shown) are disposed on one of the front surface and the reverse surface (that is, the first display surface 131 and the second display surface 132) of the substrate 134B, and an optical component (not shown) is utilized to emit the light toward the other of the front surface and the reverse surface (that is, the first display surface 131 and the second display surface 132), without being limited thereto.

In detail, in the present embodiment, a distance D3 between the first display surface 131 and the second display surface 132 of each transparent double-sided display panel 130B is greater than 0. In other words, since the distance D3 between the first display surface 131 and the second display surface 132 is greater than 0, when each transparent double-sided display panel 130B is at a same point of time, the display image of the first display surface 131 and the display image of the second display surface 132 are two-dimensional images of different sectional surfaces of the three-dimensional object (not shown).

In more details, in the present embodiment, since the transparent double-sided display panels 130B rotate along with the rotating table (not shown) relative to the base (not shown), the display image of the first display surface 131 and the display image of the second display surface 132 of each transparent double-sided display panel 130B are two-dimensional images of different sectional surfaces of the three-dimensional object (not shown).

In other words, in the present embodiment, the rotating table (not shown) rotates along with the transparent double-sided display panels 130B relative to the base (not shown), and each transparent double-sided display panel 130B is transparent and displays on both sides, such that each transparent double-sided display panel 130B may display two dimensional images of different sectional surfaces of the three-dimensional object (not shown) at different points of time, thereby forming a continuous three-dimensional stereoscopic image of the three-dimensional object (not shown) to be displayed through visual persistence, thus further generating continuous three-dimensional stereoscopic image viewable with naked eyes, without being limited by the viewing angle.

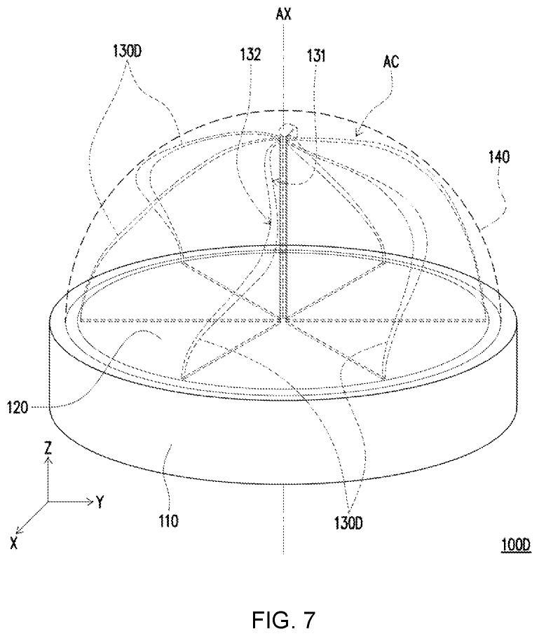

FIG. 6 is a side schematic view of one of the transparent double-sided display panels of a three-dimensional display device according to another embodiment of the present disclosure. Referring simultaneously to FIG. 6 and FIG. 3A, the transparent double-sided display panels 130C in the present embodiment are similar to the transparent double-sided display panels 130 of FIG. 3A, and the difference between the two exists in that the transparent double-sided display panels 130C have a plurality of through holes 135.

Referring to FIG. 6, in the present embodiment, the contour of each transparent double-sided display panel 130C is substantially a quarter circle, and each transparent double-sided display panel 130C has a plurality of through holes 135. Thus, the through holes 135 on each transparent double-sided display panel 130C may be utilized to reduce the resistance exerted by the air when the transparent double-sided display panels 130C rotate, thereby avoiding damage to the transparent double-sided display panels 130C and reducing the power consumption required for the rotation.

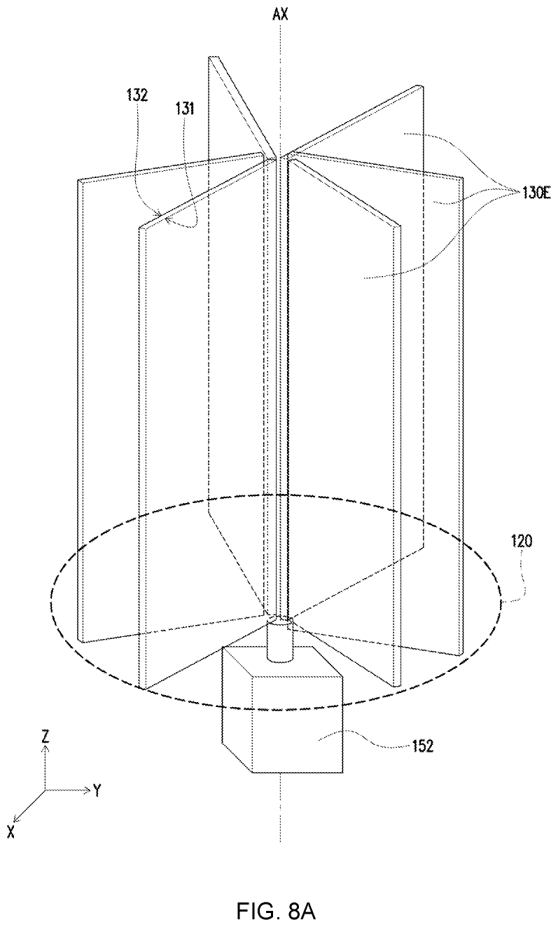

FIG. 7 is a perspective schematic view of a three-dimensional display device according to another embodiment of the present disclosure. Referring simultaneously to FIG. 7 and FIG. 1, the three-dimensional display device 100D in the present embodiment is similar to the three-dimensional display device 100 of FIG. 1, and the difference between the two exist in the outer contour of the transparent double-sided display panels 130D.

Referring to FIG. 7, the three-dimensional display device 100D in the present embodiment includes a base 110, a rotating table 120 and six transparent double-sided display panels 130D. The rotating table 120 is rotatably connected to the base 110. The six transparent double-sided display panels 130D are disposed on the rotating table 120, and each transparent double-sided display panel 130D has a first display surface 131 and a second display surface 132 opposite to each other, allowing the rotating table 120 to rotate along with the six transparent double-sided display panels 130D relative to the base 110.

In detail, in the present embodiment, the contour of each transparent double-sided display panel 130D is streamline-shaped. In other words, in the present embodiment, the three-dimensional display device 100D does not need to evacuate the vacuum to maintain a vacuum state in the accommodating space AC, and instead, the streamline-shaped transparent double-sided display panels 130D are utilized to reduce the resistance exerted by the air when the transparent double-sided display panels 130D rotate, thereby avoiding damage to the transparent double-sided display panels 130D and reducing the power consumption required for the rotation, without being limited thereto.

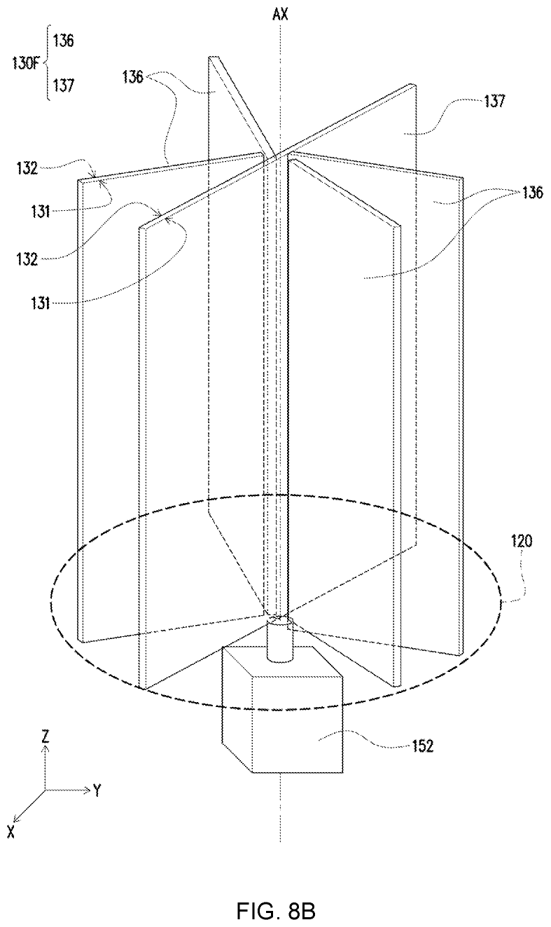

FIG. 8A is a perspective schematic view of a rotating table, transparent double-sided display panels and a motor of a three-dimensional display device according to another embodiment of the present disclosure. To clearly describe the structures between the rotating table 120, the transparent double-sided display panels 130E and the motor 152, FIG. 8A depicts the rotating table 120 in broken lines. Referring simultaneously to FIG. 8A and FIG. 2, the transparent double-sided display panels 130E in the present embodiment are similar to the transparent double-sided display panels 130 of FIG. 2, and the difference between the two exists in the outer contour of the transparent double-sided display panels 130E.

Referring to FIG. 8A, in the present embodiment, the rotating table 120 is rotatably connected to the base (not shown). The six transparent double-sided display panels 130E are disposed on the rotating table 120, and each transparent double-sided display panel 130E has a first display surface 131 and a second display surface 132 opposite to each other, allowing the rotating table 120 to rotate along with the six transparent double-sided display panels 130E relative to the base (not shown).

In details, in the present embodiment, the rotating table 120 is, for example, a round-shaped rotating table rotating around a rotation axis AX (parallel to the Z-axis). The six transparent double-sided display panels 130E are, for example, arranged radially with the rotation axis AX as the central axis, and the contour of each transparent double-sided display panel 130E is rectangular.

Further, in the present embodiment, a distance between the first display surface 131 and the second display surface 132 of each transparent double-sided display panel 130E is greater than 0. In other words, since the distance between the first display surface 131 and the second display surface 132 is greater than 0, when each transparent double-sided display panel 130E is at a same point of time, the display image of the first display surface 131 and the display image of the second display surface 132 are two-dimensional images of different sectional surfaces of the three-dimensional object (not shown).

Further, in the present embodiment, the motor 152 is fixed to the base (not shown) and drives the rotating table 120 to rotate, such that the six transparent double-sided display panels 130E disposed on the rotating table 120 also rotate relative to the base (not shown), thereby allowing the display image of the first display surface 131 and the display image of the second display surface 132 of each transparent double-sided display panel 130E to form two-dimensional images of different sectional surfaces of the three-dimensional object (not shown) at different points of time.

In other words, in the present embodiment, the rotating table 120 rotates along with the transparent double-sided display panels 130E relative to the base (not shown), and each transparent double-sided display panel 130E is transparent and displays on both sides, such that each transparent double-sided display panel 130E may display two dimensional images of different sectional surfaces of the three-dimensional object (not shown) at different points of time, thereby forming a continuous three-dimensional stereoscopic image of the three-dimensional object (not shown) to be displayed through visual persistence, thus further generating continuous three-dimensional stereoscopic image viewable with naked eyes, without being limited by the viewing angle.

FIG. 8B is a perspective schematic view of a rotating table, transparent double-sided display panels and a motor of a three-dimensional display device according to a further embodiment of the present disclosure. To clearly describe the structures between the rotating table 120, the transparent double-sided display panels 130F and the motor 152, FIG. 8B depicts the rotating table 120 in broken lines. Referring simultaneously to FIG. 8B and FIG. 8A, the transparent double-sided display panels 130F in the present embodiment are similar to the transparent double-sided display panels 130E of FIG. 8A, and the difference between the two exists in that the transparent double-sided display panels 130F include a first transparent double-sided display panel 136 and four second transparent double-sided display panels 137.

Referring to FIG. 8B, in the present embodiment, the rotating table 120 is rotatably connected to the base (not shown), and the transparent double-sided display panels 130F are disposed on the rotating table 120, allowing the rotating table 120 to rotate along with the transparent double-sided display panels 130F relative to the base (not shown).

In detail, in the present embodiment, the transparent double-sided display panels 130F include a first transparent double-sided display panel 136 and four second transparent double-sided display panels 137, and the first transparent double-sided display panel 136 and each second transparent double-sided display panel 137 respectively have a first display surface 131 and a second display surface 132 opposite to each other.

In more details, in the present embodiment, the rotating table 120 is, for example, a round-shaped rotating table rotating around a rotation axis AX (parallel to the Z-axis), and the contour of the first transparent double-sided display panel 136 and each second transparent double-sided display panel 137 is rectangular. The first transparent double-sided display panel 136 is a display panel passing through the rotation axis AX (parallel to the Z-axis), and the four second transparent double-sided display panels 137 are disposed on the rotating table 120 radially with the rotation axis AX (parallel to the Z-axis) as the central axis.

Further, in the present embodiment, a distance between the first display surface 131 and the second display surface 132 of the first transparent double-sided display panel 136 and a distance between the first display surface 131 and the second display surface 132 of each second transparent double-sided display panel 137 are greater than 0. In other words, since the distance between the first display surface 131 and the second display surface 132 is greater than 0, when the first transparent double-sided display panel 136 and each second transparent double-sided display panel 137 are at a same point of time, the display image of the first display surface 131 and the display image of the second display surface 132 are two-dimensional images of different sectional surfaces of the three-dimensional object (not shown).

Further, in the present embodiment, the motor 152 is fixed to the base (not shown) and drives the rotating table 120 to rotate, such that the transparent double-sided display panels 130F disposed on the rotating table 120 also rotate relative to the base (not shown), thereby allowing the display image of the first display surface 131 and the display image of the second display surface 132 of the first transparent double-sided display panel 136 and each second transparent double-sided display panel 137 to form two-dimensional images of different sectional surfaces of the three-dimensional object (not shown) at different points of time.

In other words, in the present embodiment, the rotating table 120 rotates along with the transparent double-sided display panels 130F relative to the base (not shown), and each transparent double-sided display panel 130F is transparent and displays on both sides, such that each transparent double-sided display panel 130F may display two dimensional images of different sectional surfaces of the three-dimensional object (not shown) at different points of time, thereby forming a continuous three-dimensional stereoscopic image of the three-dimensional object (not shown) to be displayed through visual persistence, thus further generating continuous three-dimensional stereoscopic image viewable with naked eyes, without being limited by the viewing angle.

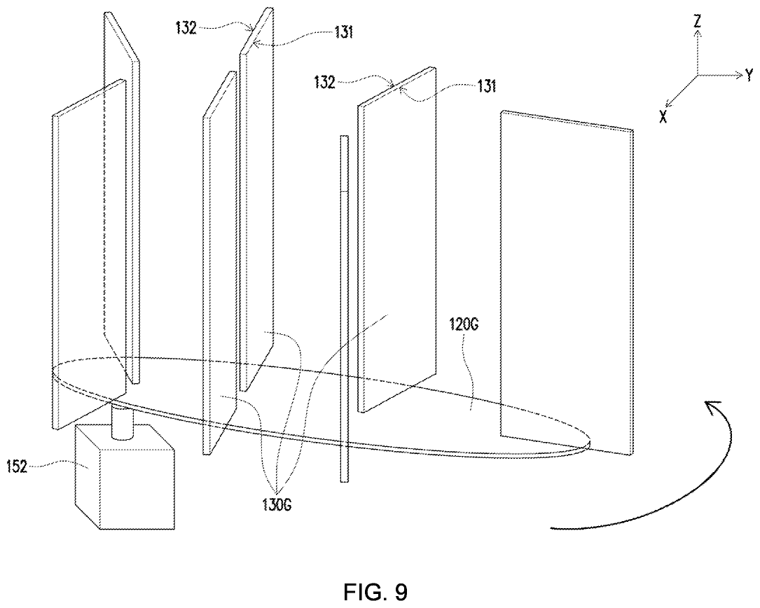

FIG. 9 is a perspective schematic view of a rotating table, transparent double-sided display panels and a motor of a three-dimensional display device according to yet another embodiment of the present disclosure. Referring simultaneously to FIG. 9 and FIG. 8A, the transparent double-sided display panels 130G in the present embodiment are similar to the transparent double-sided display panels 130E of FIG. 8A, and the difference between the two exists in that the quantity of the transparent double-sided display panels 130G is seven, and the transparent double-sided display panels 130G are arranged on a rotating table 120G in an ellipse shape.

Referring to FIG. 9, in the present embodiment, the rotating table 120G is rotatably connected to the base (not shown), and the seven transparent double-sided display panels 130G are disposed on the rotating table 120G, allowing the rotating table 120G to rotate along with the seven transparent double-sided display panels 130G relative to the base (not shown).

In detail, in the present embodiment, each transparent double-sided display panel 130G has a first display surface 131 and a second display surface 132 opposite to each other. The rotating table 120 is, for example, a ellipse-shaped rotating table, and the contour of each transparent double-sided display panel 130G is rectangular. A distance between the first display surface 131 and the second display surface 132 of each transparent double-sided display panel 130G is greater than 0. In other words, since the distance between the first display surface 131 and the second display surface 132 is greater than 0, when each transparent double-sided display panel 130G is at a same point of time, the display image of the first display surface 131 and the display image of the second display surface 132 are two-dimensional images of different sectional surfaces of the three-dimensional object (not shown).

Further, in the present embodiment, the motor 152 is fixed to the base (not shown) and drives the rotating table 120G to rotate, such that the seven transparent double-sided display panels 130G disposed on the rotating table 120G also rotate relative to the base (not shown), thereby allowing the display image of the first display surface 131 and the display image of the second display surface 132 of each transparent double-sided display panel 130G to form two-dimensional images of different sectional surfaces of the three-dimensional object (not shown) at different points of time.

In other words, in the present embodiment, the rotating table 120G rotates along with the seven transparent double-sided display panels 130G relative to the base (not shown), and each transparent double-sided display panel 130G is transparent and displays on both sides, such that each transparent double-sided display panel 130G may display two dimensional images of different sectional surfaces of the three-dimensional object (not shown) at different points of time, thereby forming a continuous three-dimensional stereoscopic image of the three-dimensional object (not shown) to be displayed through visual persistence, thus further generating continuous three-dimensional stereoscopic image viewable with naked eyes, without being limited by the viewing angle.

In sum, in the three-dimensional display device according to certain embodiments of the present disclosure, the rotating table rotates along with the transparent double-sided display panel relative to the base, and each transparent double-sided display panel is transparent and displays on both sides, such that each transparent double-sided display panel may display two dimensional images of different sectional surfaces of a three-dimensional object at different points of time, thereby allowing the transparent double-sided display panel to form a continuous three-dimensional stereoscopic image of the object to be displayed through visual persistence.

Thus, the three-dimensional display device according to certain embodiments of the present disclosure may generate a continuous three-dimensional stereoscopic image viewable with naked eyes by the base, the rotating table and the transparent double-sided display panel, such that the viewer may directly perceive the distance and depth of the object in the image, and may obtain more comprehensive and intuitive information without being limited by the viewing angle.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A three-dimensional display device, comprising:
a base;
a rotating table, rotatbly connected to the base; and
at least one transparent double-sided display panel, disposed on the rotating table, and having a first display surface and a second display surface opposite to each other.

2. The three-dimensional display device according to claim 1, wherein the first display surface and the second display surface of each of the at least one transparent double-sided display panel have different display images at a same point of time.

3. The three-dimensional display device according to claim 2, wherein a distance between the first display surface and the second display surface is greater than 0, and at the same point of time, the display image of the first display surface and the display image of the second display surface are two-dimensional images of different sectional surfaces of a three-dimensional object.

4. The three-dimensional display device according to claim 1, further comprising a circuit assembly, wherein the rotating table has an upper surface and a lower surface opposite to each other, the at least one transparent double-sided display panel is disposed on the upper surface, the circuit assembly is disposed on the lower surface, and the circuit assembly is located between the base and the at least one transparent double-sided display panel.

5. The three-dimensional display device according to claim 4, wherein the circuit assembly comprises at least one driving circuit board, a motor and at least one battery, the motor and the at least one battery are electrically connected to the at least one driving circuit board, and the motor drives the rotating table to rotate.

6. The three-dimensional display device according to claim 5, wherein the circuit assembly further comprises a wireless charging coil, and the wireless charging coil is disposed on the base and corresponds to the at least one battery to perform wireless charging to the at least one battery.

7. The three-dimensional display device according to claim 1, further comprising a plurality of ball bearings, wherein the base comprises a plurality of bearing fixing portions, the ball bearings are respectively disposed on the corresponding bearing fixing portions, and the ball bearings are connected between the base and the rotating table.

8. The three-dimensional display device according to claim 1, further comprising a transparent cover, wherein the transparent cover and the base are hermetically combined to form an accommodating space, and the rotating table and the at least one transparent double-sided display panel are located in the accommodating space.

9. The three-dimensional display device according to claim 1, wherein each of the at least one transparent double-sided display panel has a plurality of through holes.
